(19) United States
(12) Patent Application Publication
(10) Pub. No.: US 2020/0327454 A1
(43) Pub. Date: Oct. 15, 2020

(54) SECURED DEPLOYMENT OF MACHINE LEARNING MODELS

(71) Applicant: Intel Corporation, Santa Clara, CA (US)

(72) Inventors: Cheng-Long Chuang, Chandler, AZ (US); Olorunfunmi A Oliyide, San Jose, CA (US); Raemin Wang, San Francisco, CA (US); Jahanzeb Ahmad, Chesham (GB); Adam Titley, Bracknell (GB)

(21) Appl. No.: 16/913,923

(22) Filed: Jun. 26, 2020

(51) Int. Cl. G06N 20/00; G06F 21/60; G06F 9/38; G06F 15/78

(52) U.S. Cl. CPC G06N 20/00; G06F 21/602; G06F 2015/768; G06F 15/7867; G06F 9/3836

(57) ABSTRACT

A system includes a programmable logic device including a communication interface configured to receive an encrypted deep learning model and a first key in a bitstream. In an embodiment, the programmable logic device includes a storage block configured to store the first key. The programmable logic device also includes a decryption block configured to decrypt the deep learning model using the first key. A method includes receiving, at a programmable logic device, the encrypted deep learning model and a first key in a bitstream. The method also includes decrypting, at the programmable logic device, the deep learning model using the first key. The method also includes implementing the deep learning model on the programmable logic device.

### BACKGROUND

The present disclosure relates generally to integrated circuit (IC) devices such as programmable logic devices (PLDs). More particularly, the present disclosure relates to providing secure deployment of machine learning models using PLDs, such as field programmable gate arrays (FPGAs).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuit devices may be utilized for a variety of purposes or applications, such as encryption, decryption, digital signal processing, and machine learning. Indeed, machine learning and artificial intelligence applications, such as deep learning models, have become ever more prevalent. Programmable logic devices may be utilized to perform these functions. In some cases, a creator (e.g., person, group, company, entity) of a machine learning model may be different than a designer (e.g., person, group, company, entity) responsible for the circuit design of a programmable logic device intended to implement the machine learning model. As such, the creator of the machine learning model may seek to protect the machine learning model by encrypting the machine learning model and/or may seek to prevent the designer of the programmable logic device circuit design from receiving and/or handling the machine learning model in an unencrypted form in order to maintain secrecy and privacy of the machine learning model. In some cases, decryption of machine learning models before use may potentially expose valuable data to theft and/or corruption.

### BRIEF DESCRIPTION OF THE DRAWINGS

Various aspects of this disclosure may be better understood upon reading the following detailed description and upon reference to the drawings in which:

FIG. 1 is a block diagram of a system that may implement arithmetic operations using a DSP block, in accordance with an embodiment of the present disclosure;

FIG. 2 is a block diagram of the integrated circuit device of FIG. 1, in accordance with an embodiment of the present disclosure;

FIG. 3 is a flow diagram of a process for encrypting a deep learning model, in accordance with an embodiment of the present disclosure;

FIG. 4 is a data processing system for decrypting the deep learning model of FIG. 3, in accordance with an embodiment of the present disclosure.

FIG. 5 is a data processing system, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

As machine learning applications have become ever more prevalent, there is a growing desire for secured methods to ensure machine learning models are sufficiently protected. The present systems and techniques relate to embodiments of systems and methods for encrypting and securing deployment of machine learning models in programmable logic devices. A first entity may be responsible for creating and/or generating a machine learning model (e.g., deep learning model, neural network, support vector machine). A second entity may be responsible for a circuit design of a programmable logic device to implement the machine learning model. In some cases, the circuit design may be a portion of a bitstream (e.g., configuration program) for programming the programmable logic device and the programmable logic device may be a field-programmable gate array (FPGA). In some cases, the bitstream may be encrypted with a first encryption key and a second portion of the bitstream may include the encrypted machine learning model.

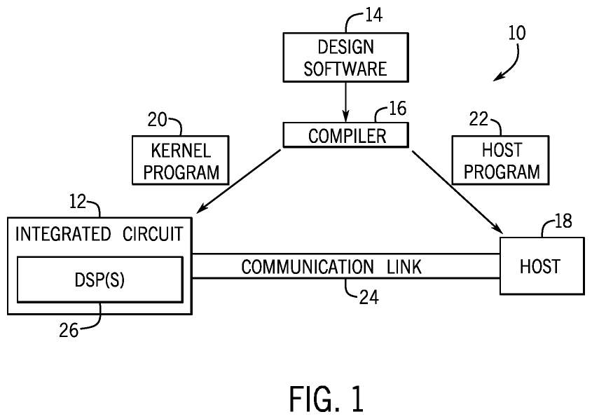

With this in mind, FIG. 1 illustrates a block diagram of a system 10 that may implement arithmetic operations using components of an integrated circuit device, such as components of a programmable logic device (e.g., a configurable logic block, an adaptive logic module, a DSP block). A designer may desire to implement functionality, such as the deep learning model encryption, decryption, and/or implementation operations of this disclosure, on an integrated circuit device 12 (such as a field-programmable gate array (FPGA) or an application-specific integrated circuit (ASIC)). In some cases, the designer may specify a high-level program to be implemented, such as an OpenCL program, which may enable the designer to more efficiently and easily provide programming instructions to configure a set of programmable logic cells for the integrated circuit device 12 without specific knowledge of low-level hardware description languages (e.g., Verilog or VHDL). For example, because OpenCL is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designers may implement their high-level designs using design software 14, such as a version of Intel® Quartus® by INTEL CORPORATION. The design software 14 may use a compiler 16 to convert the high-level program into a lower-level description. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of one or more DSP blocks 26 on the integrated circuit device 12. The DSP block 26 may include circuitry to implement, for example, operations to perform matrix-matrix or matrix-vector multiplication for AI or non-AI data processing. The integrated circuit device 12 may include many (e.g., hundreds or thousands) of the DSP blocks 26. Additionally, DSP blocks 26 may be communicatively coupled to another such that data outputted from one DSP block 26 may be provided to other DSP blocks 26.

While the techniques described above refer to the application of a high-level program, in some embodiments, the designer may use the design software 14 to generate and/or to specify a low-level program, such as the low-level hardware description languages described above. Further, in some embodiments, the system 10 may be implemented without a separate host program 22. Moreover, in some embodiments, the techniques described herein may be implemented in circuitry as a non-programmable circuit design. Thus, embodiments described herein are intended to be illustrative and not limiting.

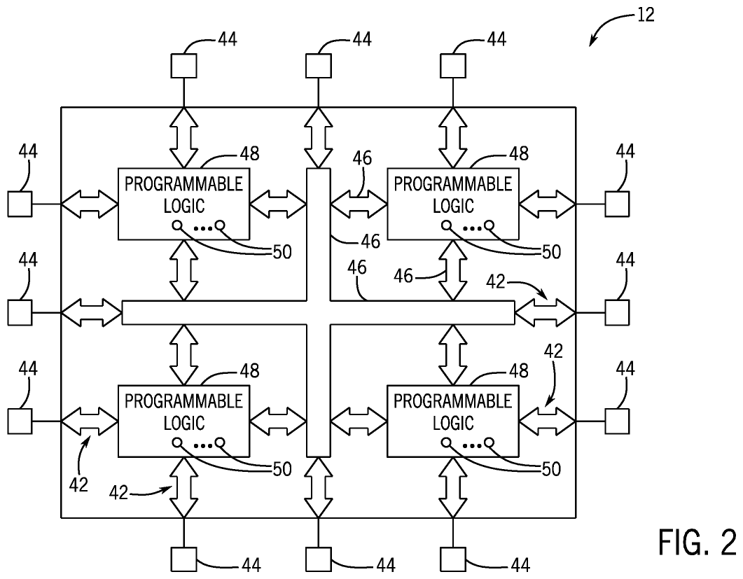

Turning now to a more detailed discussion of the integrated circuit device 12, FIG. 2 illustrates an example of the integrated circuit device 12 as a programmable logic device, such as a field-programmable gate array (FPGA). Further, it should be understood that the integrated circuit device 12 may be any other suitable type of integrated circuit device (e.g., an application-specific integrated circuit and/or application-specific standard product). As shown, the integrated circuit device 12 may have input/output circuitry 42 for driving signals off device and for receiving signals from other devices via input/output pins 44. Interconnection resources 46, such as global and local vertical and horizontal conductive lines and buses, may be used to route signals on integrated circuit device 12. Additionally, interconnection resources 46 may include fixed interconnects (conductive lines) and programmable interconnects (e.g., programmable connections between respective fixed interconnects). Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of the programmable logic 48.

Programmable logic devices, such as integrated circuit device 12, may contain programmable elements 50 within the programmable logic 48. For example, as discussed above, a designer (e.g., a customer) may program (e.g., configure) the programmable logic 48 to perform one or more desired functions. By way of example, some programmable logic devices may be programmed by configuring their programmable elements 50 using mask programming arrangements, which is performed during semiconductor manufacturing. Other programmable logic devices are configured after semiconductor fabrication operations have been completed, such as by using electrical programming or laser programming to program their programmable elements 50. In general, programmable elements 50 may be based on any suitable programmable technology, such as fuses, antifuses, electrically-programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using pins 44 and input/output circuitry 42. In one embodiment, the memory cells may be implemented as random-access-memory (RAM) cells. The use of memory cells based on RAM technology is described herein is intended to be only one example. Further, because these RAM cells are loaded with configuration data during programming, they are sometimes referred to as configuration RAM cells (CRAM). These memory cells may each provide a corresponding static control output signal that controls the state of an associated logic component in programmable logic 48. For instance, in some embodiments, the output signals may be applied to the gates of metal-oxide-semiconductor (MOS) transistors within the programmable logic 48.

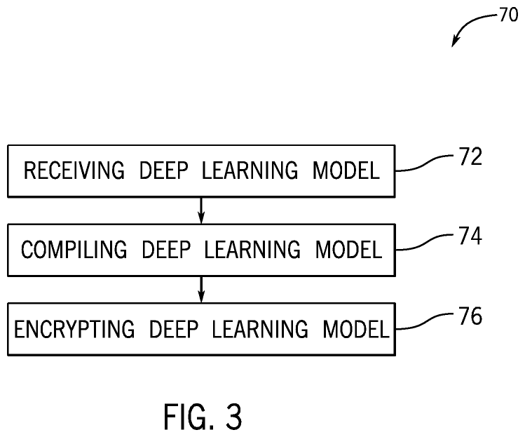

FIG. 3 illustrates a flow diagram of a process 70 for encrypting a deep learning model, according to embodiments of the present disclosure. While the process 70 is described as being performed by a host processor, such as host 18 in FIG. 1, it should be understood that the process 70 may be performed by any suitable processing circuitry. Furthermore, while the process 70 is described using steps in a specific sequence, it should be understood that the present disclosure contemplates that the described steps may be performed in different sequences than the sequence illustrated, and certain described steps may be implemented by executing instructions stored in a tangible, non-transitory, computer-readable medium using any suitable processing circuitry.

In the process 70, a deep learning model may be received at a host (step 72), such as host 18 in FIG. 1. In certain embodiments, the host may generate or may train the deep learning model. For example, the deep learning model may receive training inputs and may generate outputs, such as classifying photos. The deep learning model may include a set of plain text weights associated with implementing the deep learning model.

In the process 70, a compiler of the host may compile the deep learning model (step 74). In certain embodiments, the compiler generates a set of binary execution codes based on the deep learning model. The set of binary execution codes define a schedule of computation associated with the deep learning model. The binary execution codes, when executed by suitable processing circuitry or an integrated circuit device, such as an FPGA, will implement the deep learning model.

In the process 70, the host may encrypt (step 76) the set of binary execution codes of the deep learning model to generate an encrypted deep learning model. The host may use any suitable standard encryption technique, such as Advanced Encryption Standard (AES), and/or any suitable non-standard encryption technique to generate the encrypted deep learning model. The plain text, or unencrypted form of the deep learning model, may be encrypted by receiving a key from a stored key database (e.g., keys that were stored and are unique to the FPGA) and by encrypting the plain text with the key. In certain embodiments, the deep learning model may be encrypted using an asymmetric encryption technique. As such, the deep learning model may be encrypted using a first key and may be decrypted using a second, separate key. In some embodiments, the encryption is performed offline to reduce the opportunity for hackers to obtain information. Once the deep learning model has been encrypted, decryption of the deep learning model must be performed before the deep learning model can be used.

The host may use a model encryption key to encrypt the set of binary execution codes and may retain the model encryption key used to encrypt the set of binary execution codes, such as in a host memory. In some embodiments, the model encryption key corresponds to a key that is housed on the FPGA. The keys stored on the FPGA are unique to the FPGA and are only known by the deep learning model owner. Likewise, the keys cannot be obtained externally, minimizing risk of memory leakage through I/O requests. Through the use of keys that are unique to the FPGA, the need for transmitting keys between the host and FPGA is reduced because the keys used to encrypt the data on the host are already embedded in the FPGA that can be used to decrypt once received, as described herein. Additionally or alternatively, the transfer of keys between the host and FPGA may occur due to an update, such as an update of a decryption block on the FPGA. In certain embodiments, a new decryption key associated with the encrypted deep learning model may be transferred between the host and the FPGA in an encrypted bitstream. For example, the model encryption key may be formed from any number of programmable elements on a programmable logic device, such as programmable elements 50 in FIG. 2, including physical fuses, virtual fuses, and so forth. In certain embodiments, the model encryption key may be fused on the FPGA. In some embodiments, the encryption key may be a private key that is generated on the host and only known by the deep learning model owner. When a private key is used to encrypt the deep learning model (and encrypted), the private key may be further encrypted using a key embedded in the FPGA.

In some embodiments, the process 70 includes encrypting both the deep learning model and the encryption key (e.g., private encryption key generated by the host or a key generated on the FPGA) using an encryption technique. By encrypting both the deep learning model and the model encryption key, the integrity of the deep learning model and the model encryption key are maintained. That is, if the resulting bitstream is tampered or modified, both the data and the model encryption key are assumed to be compromised. In some embodiments, the model encryption key that is used to encrypt and/or decrypt the deep learning model is itself separately encrypted by another key that is unique to the FPGA. As such, the deep learning model may be encrypted and may be protected from the entity responsible for the circuit design of the programmable logic device.

In certain embodiments, once the deep learning model, and encryption key as may be present in some embodiments, has been encrypted, the FPGA bitstream may be stored and may be prepared for transmittal as described herein.

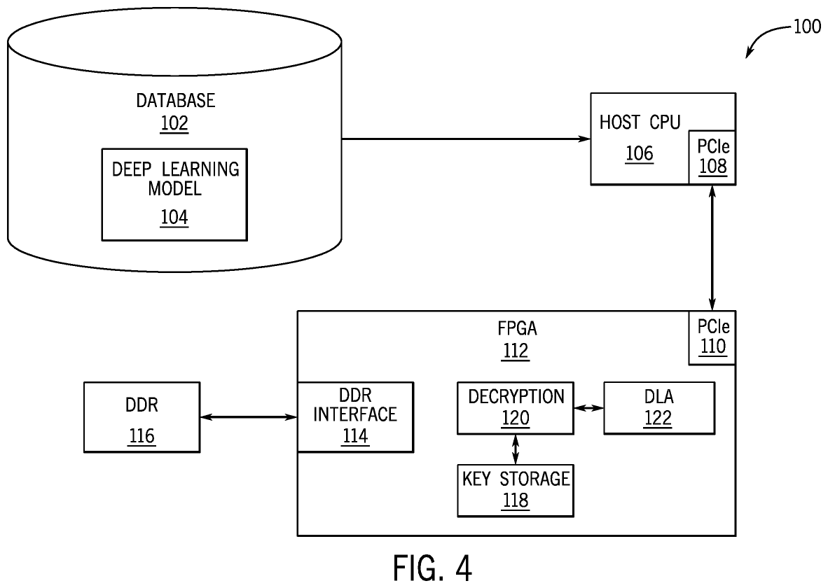

FIG. 4 illustrates components of a data processing system 100 used to implement the deep learning model encryption, decryption, and/or implementation methods, in accordance with an embodiment of the present disclosure. As shown, an encrypted deep learning model 104 may be stored in a database 102. In certain embodiments, the database 102 may be associated with a host, such as host 18 in FIG. 1. In certain embodiments, a first entity may create and/or generate the encrypted deep learning model 104. In some embodiments, the first entity may encrypt the deep learning model. The encrypted deep learning model 104 may be compiled and stored as a set of binary execution codes. In some embodiments, the encrypted deep learning model may be generated, such as by the first entity, by the process 70 of FIG. 3. A host processor (e.g., host central processing unit (CPU) 106)) may receive or may retrieve the encrypted deep learning model. The host CPU 106 may transmit a configuration bitstream to the FPGA 112 using a peripheral component interconnect express (PCIe) 108. In certain embodiments, a circuit design for a programmable logic device may be associated with a second entity, separate from the first entity associated with the creation and/or generation of the encrypted deep learning model. In some embodiments, the configuration bitstream may include a first portion associated with a circuit design for a programmable logic device, such as FPGA 112. For example, the configuration bitstream may include machine-readable instructions associated with functionality of an integrated circuit device, such as FPGA 112. For example, the configuration bitstream may include machine-readable instructions associated with implementing a deep learning model. The configuration bitstream may include the encrypted deep learning model 104 and the model encryption key used for encryption of the deep learning model. In certain embodiments, the model encryption key itself may be encrypted with a second key that is embedded in the FPGA. In certain embodiments, the configuration bitstream may include a first portion associated with a circuit design for the programmable logic device and a second portion associated with the encrypted deep learning model. Additionally or alternatively, the configuration bitstream may include a first portion associated with a circuit design for the programmable logic device and a second portion associated with a decryption key for decrypting the deep learning model. In some embodiments, the encrypted deep learning model may be provided to the programmable logic device by a remote device via a network. For example, the encrypted deep learning model may be provided to memory associated with the FPGA 112.

The FPGA 112 may be coupled to the host processor (e.g., host central processing unit (CPU) 106). In certain embodiments, the host CPU 106 may store the encrypted deep learning model in memory associated with the host CPU 106, such as a host double data rate (DDR) memory. In some embodiments, the host DDR memory may transfer the encrypted deep learning model 104 to memory associated with the FPGA 112, such as FPGA DDR memory 116.

Additionally or alternatively, the host CPU 106 may transfer the encrypted deep learning model 104 from a remote device to memory associated with the FPGA 112, such as FPGA DDR memory 116. In some embodiments, the encrypted deep learning model 104 may be deployed from a remote device via a network. The FPGA DDR memory 116 may be separate from, but communicatively coupled to the FPGA 112 using a DDR communication interface 114 that facilitates communication between the FPGA DDR memory 116 and the FPGA 114 according to, for example, the PCIe bus standard. Upon receiving an indication from the host CPU 106, the encrypted deep learning model 104 and model encryption key may be transferred from the FPGA DDR memory 116 to the FPGA 112 using the DDR communication interface 114. In some embodiments, the deep learning model 104 may be transferred directly from the host CPU 106 to the FPGA 112 using PCIe 108, 110, with or without temporary storage in the host DDR.

In certain embodiments, the FPGA DDR memory 116 may include a multiplexer, that determines which data stored in FPGA DDR memory 116 should be decrypted. For example, if a request to decrypt the encrypted deep learning model 104 is received, the multiplexer may identify and/or may isolate the portion of memory that contains the encrypted deep learning model 104 and/or the encrypted decryption key for the deep learning model 104 to be decrypted. That is, the multiplexer may identify only the data that needs to be decrypted in order to avoid decrypting the entire FPGA memory DDR 116. In certain embodiments, the model encryption key may be stored in a key storage 118 of the FPGA 112. For instance, the model encryption key may be one of many keys that have been generated for use on the FPGA that are unique to the FPGA. In some embodiments, the FPGAs, when manufactured, are programmed to include a set of encryption keys. Additionally or alternatively, the DDR communication interface 114 may include the multiplexer that identifies data in the FPGA memory DDR 116 that needs to be decrypted. The encrypted deep learning model 104 may be transferred to a portion of the FPGA 112 programmed to decrypt and/or implement the deep learning model architecture. The decryption component 120 may use the model decryption key stored in key storage 118 to unencrypt the deep learning model. Likewise, if a second key is used to encrypt the model encryption key, another decryption key stored in key storage 118 may be used to decrypt the model encryption key, which can then be used to decrypt the deep learning model. In some embodiments, the deep learning model, when unencrypted, may be stored in binary code execution codes. The deep learning model in unencrypted form may be transmitted from the decryption component 120 to the deep learning accelerator (DLA) 122 for implementation of the deep learning model.

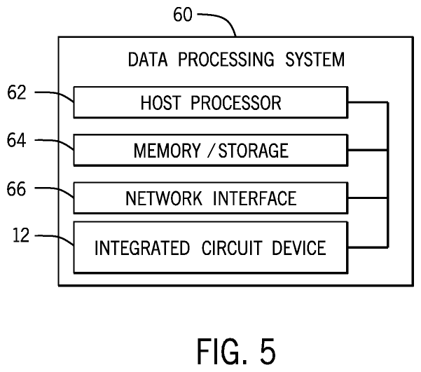

The integrated circuit device 12 may be a data processing system or a component included in a data processing system. For example, the integrated circuit device 12 may be a component of a data processing system 60 shown in FIG. 5. The data processing system 60 may include a host processor 62 (e.g., a central-processing unit (CPU)), memory and/or storage circuitry 64, and a network interface 66. The data processing system 60 may include more or fewer components (e.g., electronic display, user interface structures, application specific integrated circuits (ASICs)). The host processor 62 may include any suitable processor, such as an INTEL® Xeon® processor or a reduced-instruction processor (e.g., a reduced instruction set computer (RISC), an Advanced RISC Machine (ARM) processor) that may manage a data processing request for the data processing system 60 (e.g., to perform encryption, decryption, machine learning, video processing, voice recognition, image recognition, data compression, database search ranking, bioinformatics, network security pattern identification, spatial navigation, or the like). The memory and/or storage circuitry 64 may include random access memory (RAM), read-only memory (ROM), one or more hard drives, flash memory, or the like. The memory and/or storage circuitry 64 may hold data to be processed by the data processing system 60. In some cases, the memory and/or storage circuitry 64 may also store configuration programs (bitstreams) for programming the integrated circuit device 12. The network interface 66 may allow the data processing system 60 to communicate with other electronic devices. The data processing system 60 may include several different packages or may be contained within a single package on a single package substrate.

In one example, the data processing system 60 may be part of a data center that processes a variety of different requests. For instance, the data processing system 60 may receive a data processing request via the network interface 66 to perform encryption, decryption, machine learning, video processing, voice recognition, image recognition, data compression, database search ranking, bioinformatics, network security pattern identification, spatial navigation, digital signal processing, or some other specialized task.

Accordingly, the techniques described herein enable particular applications to be carried out using encryption and/or implementation of deep learning models on a programmable logic device, such as an FPGA. For example, encryption of a deep learning model to be implemented on an FPGA, such as FPGA 112, protects valuable the DSP block 26 enhances the ability of integrated circuit devices, such as programmable logic devices (e.g., FPGAs), be utilized for artificial intelligence applications while still being suitable for digital signal processing applications.

While the embodiments set forth in the present disclosure refer to deep learning models, it should be understood that the disclosure is not intended to be limited to such deep learning models. The disclosure is to cover all machine learning models, such as deep learning models, neural networks, classifiers, cluster analysis, support vector machines, and any other suitable machine learning model. While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method comprising:
receiving, at a programmable logic device, a first portion of an encrypted bitstream comprising a first key for an encrypted deep learning model, wherein the bitstream is decrypted using a second key;
decrypting, at the programmable logic device, the deep learning model using the first key; and
implementing the deep learning model on the programmable logic device.

2. The method of claim 1, comprising:
storing the encrypted deep learning model in a memory associated with the program logic device; and
separating the first key from the bitstream.

3. The method of claim 1, comprising storing the first key on the programmable logic device.

4. The method of claim 1, comprising decrypting the bitstream at the programmable logic device.

5. The method of claim 1, wherein a second portion of the bitstream comprises a circuit design for the programmable logic device.

6. The method of claim 1, comprising receiving, at the programmable logic device, a second portion of the bitstream comprising machine-readable instructions associated with implementing the deep learning model.

7. The method of claim 1, wherein the deep learning model comprises a set of plain text weights associated with implementing the deep learning model.

8. The method of claim 1, wherein the encrypted deep learning model comprises a set of binary execution codes defining a schedule of computation associated with the deep learning model.

9. The method of claim 1, wherein the bitstream is a configuration bitstream of a field programmable gate array (FPGA).

10. A system, comprising:
a programmable logic device, comprising:
a communication interface configured to receive an encrypted deep learning model, a first decryption key in an encrypted bitstream, and a circuit design in the encrypted bitstream;
a storage block configured to store the first decryption key; and
a decryption block configured to decrypt the deep learning model using the first decryption key.

11. The system of claim 10, wherein the programmable logic device is configured to implement the deep learning model.

12. The system of claim 10, wherein the programmable logic device comprises a double data rate memory configured to store the encrypted deep learning model.

13. The system of claim 10, wherein the circuit design is associated with functionality of the programmable logic device.

14. The system of claim 10, wherein the decryption block is configured to decrypt the bitstream using a second key.

15. The system of claim 10, wherein the first key is encrypted.

16. The system of claim 10, wherein the programmable logic device comprises a field-programmable gate array (FPGA).

17. A non-transitory, computer readable medium comprising instructions that, when executed, are configured to cause a processor to perform operations comprising:
receiving in an encrypted bitstream, at a programmable logic device, an encrypted deep learning model associated with a first entity and a circuit design associated with a second entity;
decrypting the encrypted bitstream using a first key and the encrypted deep learning model using a second key; and
implementing the deep learning model on the programmable logic device.

18. The non-transitory, computer readable medium of claim 17, wherein the first entity is a creator of the deep learning model.

19. The non-transitory, computer readable medium of claim 18, wherein the first entity is associated with encrypting the deep learning model.

20. The non-transitory, computer readable medium of claim 17, wherein the circuit design is associated with implementing the deep learning model on the programmable logic device.
